(19) United States
(12) Patent Application Publication
(10) Pub. No.: US 2009/0322954 A1
(43) Pub. Date: Dec. 31, 2009

(54) DYNAMIC SELECTION OF 3D COMB FILTER BASED ON MOTION

(75) Inventors: Louis Le, San Diego, CA (US); Tuan Pham, San Diego, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/163,462

(22) Filed: Jun. 27, 2008

(51) Int. Cl. H04N 9/78

(52) U.S. Cl. 348/665

(57) ABSTRACT

A narrower bandwidth 3D comb filter is used to render a still motion portion of a video frame if motion in a moving portion of the frame exceeds a threshold, and otherwise a wider bandwidth 3D comb filter is used to render the still motion portion.

### I. FIELD OF THE INVENTION

The present invention relates generally to dynamically selecting which of plural comb filters to use in a TV based on motion in video.

### II. BACKGROUND OF THE INVENTION

TV signals carry luminance and chrominance information. Luminance refers to how bright particular pixels should be for a given frame, essentially on a grayscale, while chrominance indicates the color of the pixels. To process the signals, a TV employs a comb filter to separate luminance from chrominance.

In some locations, particularly those that in which luminance and chrominance are not carried in the signal 180 degrees out of phase with each other, it happens that image artifacts known as “dot structures” can undesirably appear on the TV. As recognized herein, such artifacts may be reduced or even eliminated using dynamic comb filter selection.

### SUMMARY OF THE INVENTION

Accordingly, a TV includes a TV tuner configured to receive video having a first region in which motion occurs and a second region in which substantially no motion occurs. A TV display is configured to display the video, and a processor communicates with the TV tuner. The TV also includes a first 3D comb filter having a first bandwidth and being usable to separate luminance from chrominance in the second region and not the first region, and a second 3D comb filter having a second bandwidth narrower than the first bandwidth and being usable to separate luminance from chrominance in the second region and not the first region. The processor causes an output of the first comb filter to be used by the TV display when motion in the first region is below a motion threshold, and otherwise the processor causes an output of the second comb filter to be used by the TV display.

In another aspect, a method includes providing at least first and second comb filters in a TV, and, based at least in part on motion in video, dynamically selecting which comb filter to use to render at least one still portion of the video.

The comb filters may be 3D comb filters, and the first comb filter may have a wider bandwidth than the second comb filter, with the first comb filter being used to render the still portion of the video when the motion is below a threshold and the second comb filter otherwise being used to render the still portion of the video. Selection of which comb filter to use can include establishing a position of a switch communicating with both comb filters. The switch may receive outputs of the comb filters, or the switch may receive an input signal for the comb filters.

In yet another aspect, an apparatus includes a TV tuner configured to receive video and a processor communicating with the tuner. A first comb filter is provided that is useful in separating luminance from chrominance for a first portion of the video. Also, a second comb filter is provided that is useful in separating luminance from chrominance for the first portion of the video. The processor causes an output of the first comb filter to be used when a motion threshold is not met. Otherwise, the processor causes an output of the second comb filter to be used.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a non-limiting block diagram of a system in accordance with present principles;

FIG. 2 is a block diagram of a non-limiting comb filter circuit; and

FIG. 3 is a flow chart of logic that can be used in accordance with present principles.

### DETAILED DESCRIPTION OF THE PREFERRED EMBODIMENT

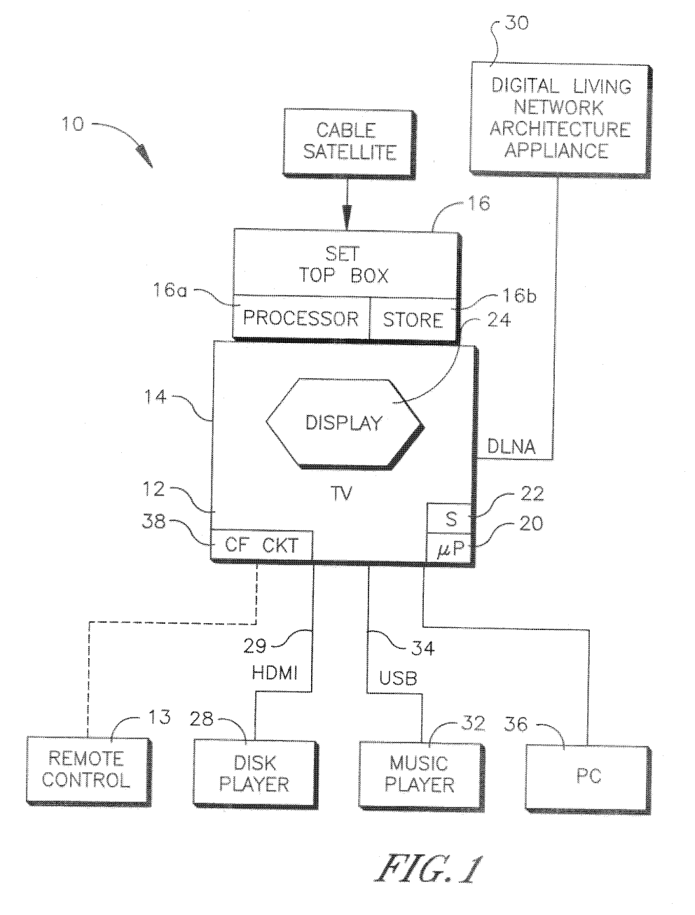

Referring initially to FIG. 1, a non-limiting system in which present principles may be used is shown, generally designated 10, which includes a television 12 controllable by a TV remote control 13 and defining a TV chassis 14 and receiving, through a TV tuner in, e.g., a set-top box 16 from a cable or satellite or other source or sources audio video TV programming. The tuner may be contained in the set box or in the TV chassis 14. When a STB is provided, the STB typically includes a STB processor 16a and STB tangible computer readable medium 16b.

Similarly, the TV 12 typically includes a TV processor 20 accessing a tangible computer readable medium 22. The tangible computer readable medium 22 may be established by, without limitation, solid state storage, optical or hard disk storage, etc. The tangible computer readable media herein may store software executable by one or more of the processors to, e.g., control a display driver that drives a TV visual display 24. The display 24 may be a flat panel matrix display, cathode ray tube, or other appropriate video display. The medium 22 may also contain additional code including 3D graphics software executable by the TV processor 20. One or more of the processors described herein may execute the logic below, which may be stored as computer code on one or more the computer readable media described herein.

In the non-limiting embodiment shown in FIG. 1 the TV 12 may receive programming from external components such as but not limited to a video disk player 28 such as a Blu-Ray or DVD player via a high definition multimedia interface (HDMI) line 29 and a digital living network architecture (DLNA) appliance 30 such as a personal video recorder (PVR) that can contain audio-video streams on a hard disk drive. The TV may also receive audio streams from a music player 32 over a universal serial bus (USB) line 34 as well as multimedia content from a personal computer 36. Additionally, in the non-limiting implementation shown the TV 12 can communicate via a network such as the Internet with content servers.

Concluding the description of FIG. 1, the TV processor 20 may communicate with a comb filter circuit 38 in the TV chassis 14 in accordance with principles discussed below. The comb filter circuit includes at least two comb filters, preferably 3D comb filters, as disclosed further herein.

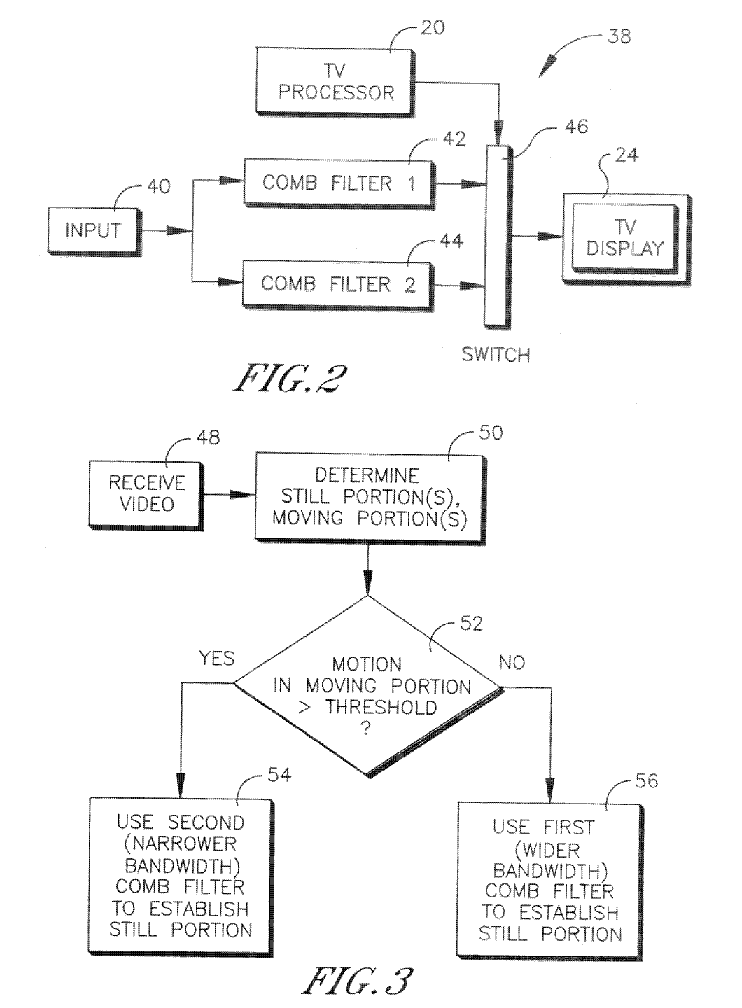

With more specificity and turning now to FIG. 2 for an understanding of one non-limiting embodiment of the comb filter circuit 38 shown in FIG. 1, input 40, which can be established by, e.g., the STB 16 shown in FIG. 1, is received and is processed by one of plural comb filters to separate luminance from chrominance in at least a portion of the video signal from the input. In the embodiment shown, a first 3D comb filter 42 and a second 3D comb filter 44 receive the input. In non-limiting embodiments the comb filters 42, 44 may be established by the comb filters colloquially known as “3D_BAND” and “3D_CVBS” that may be supplied together on a single comb filter chip. More generally, the first comb filter 42 has a wider chroma bandwidth than the second comb filter 44.

The outputs of the comb filters 42, 44 are sent to a switch 46, which is controlled by the TV processor 20 based on a motion as described below to pass the output of only one comb filter to the TV display 24. It is to be understood that while FIG. 2 illustrates a circuit in which both comb filters 42, 44 receive and process the input, with the switch 46 being downstream of the filters 42, 44 to dynamically establish which one of the outputs is sent to the display 24, in other implementations the switch 46 could be between the input 40 and filters 42, 44 such that only one filter receives and processes the input in accordance with the logic below.

FIG. 3 illustrates non-limiting logic that may be employed in accordance with present principles. Commencing at block 48, the video is received. Moving to block 50, still portion(s) and moving portion(s) of the video are determined. As an example, for each region of, e.g., ten square pixels, the number of pixels that have changed from one frame to the next can be determined and if the number does not exceed an initial threshold (which could be zero), the region is considered to be “still”, whereas if the number of changed pixels exceeds the initial threshold, the region can be considered to be “moving”. If desired, pixel changes may be averaged over plural frames such that the determination at block 50 may occur only once every plural frames.

Proceeding to decision diamond 52, the moving portion(s) are examined to determine whether motion in the portion(s) exceeds a filter selection threshold. Only the moving portion with the highest motion may be selected for the comparison at decision diamond 52, or the moving portion closest to the still portion may be selected. In any case, if the motion exceeds the threshold, the second (narrower bandwidth) comb filter 44 is selected at block 54 to render the still portion(s) of the video by, e.g., appropriately configuring the switch 46 shown in FIG. 2 to pass the output of only the second filter to the display. Otherwise, the first (wider bandwidth) comb filter 42 is selected at block 56 to render the still portion(s) of the video. It is to be understood that the thresholds herein may be empirically determined for the particular model of TV to best achieve dot structure artifact elimination.

While the particular DYNAMIC SELECTION OF 3D COMB FILTER BASED ON MOTION is herein shown and described in detail, it is to be understood that the subject matter which is encompassed by the present invention is limited only by the claims.

What is claimed is:

1. A TV, comprising:
a TV tuner configured to receive video having a first region in which motion occurs and a second region in which substantially no motion occurs;
a TV display configured to display the video;
a processor communicating with the TV tuner;
a first 3D comb filter having a first bandwidth and being usable to separate luminance from chrominance in the second region and not the first region; and
a second 3D comb filter having a second bandwidth narrower than the first bandwidth and being usable to separate luminance from chrominance in the second region and not the first region, the processor causing an output of the first comb filter to be used by the TV display when motion in the first region is below a motion threshold, and otherwise causing an output of the second comb filter to be used by the TV display.

2. Method comprising:
providing at least first and second comb filters in a TV; and
based at least in part on motion in video, dynamically selecting which comb filter to use to render at least one still portion of the video.

3. The method of claim 2, wherein the comb filters are 3D comb filters.

4. The method of claim 3, wherein the first comb filter has a wider bandwidth than the second comb filter, and the first comb filter is used to render the at least one still portion of the video when the motion is below a threshold, the second comb filter otherwise being used to render the at least one still portion of the video.

5. The method of claim 2, wherein the act of dynamically selecting includes establishing a position of a switch communicating with both comb filters.

6. The method of claim 5, wherein the switch receives outputs of the comb filters.

7. The method of claim 5, wherein the switch receives an input signal for the comb filters.

8. Apparatus comprising:
at least one TV tuner configured to receive video;
at least one processor communicating with the tuner;
at least a first comb filter useful in separating luminance from chrominance for a first portion of the video; and
at least a second comb filter useful in separating luminance from chrominance for the first portion of the video, the processor causing an output of the first comb filter to be used when a motion threshold is not met, the processor otherwise causing an output of the second comb filter to be used.

9. Apparatus of claim 8, wherein the comb filters are 3D comb filters.

10. Apparatus of claim 8, wherein the first comb filter has a wider bandwidth than the second comb filter.

11. Apparatus of claim 10, wherein the comb filters are used to separate luminance from chrominance in still portions of the video.

12. Apparatus of claim 8, comprising a switch communicating with both comb filters.

13. Apparatus of claim 12, wherein the switch receives outputs of the comb filters.

14. Apparatus of claim 12, wherein the switch receives an input signal for the comb filters.
